(19) United States
(12) Patent Application Publication
(10) Pub. No.: US 2007/0195533 A1
(43) Pub. Date: Aug. 23, 2007

(54) Light-distributing optical foil

(75) Inventor: Klaus Herbert Gunter Wenger, Maarssen (NL)

Correspondence Address: OBLON, SPIVAK, MCCLELLAND, MAIER & NEUSTADT, P.C., 1940 DUKE STREET, ALEXANDRIA, VA, 22314, US

(73) Assignee: Machinefabriek Otto Schouten B.V., JH Giessen (NL)

(21) Appl. No.: 10/561,972

(22) PCT Filed: Jun. 22, 2004
(86) PCT No.: PCT/NL04/00443

§ 371 Date: May 24, 2006

(30) Foreign Application Priority Data
Jun. 24, 2003 (NL) NL1023737

(51) Int. Cl. F21V 5/00

(52) U.S. Cl. 362/326

(57) ABSTRACT

A foil including optically refractive pyramidal elements, which each have a triangular base. The bases of adjacent elements are turned 180 degrees relative to each other. The foil has optically refractive characteristics upon incidence of electromagnetic waves thereon, which characteristics render the foil suitable for imparting a desired pattern, possibly in a desired direction, to the exiting waves. The pattern may be a uniform pattern, for example, so as to impart a uniform or diffuse light to electromagnetic waves, for example visible light, from a concentrated light source.

The present invention relates to a foil, which foil comprises optically refractive pyramidal elements, each having a triangular base.

The invention furthermore relates to a lighting system comprising such a foil and a light source, as well as to the use of such a foil.

A foil which is known as a depth perception foil is disclosed in WO 03/027755. The known foil, which has a relief structure comprising optical, pyramidal elements turned about 60 degrees relative to each other, forms part of an image display system. When images are displayed on a display screen, groups of several complementary elements arranged according to a honeycomb structure are irradiated by the same pixel. As a result, the left-hand eye and the right-hand eye of an observer receive different light intensities, so that a perception of depth in the images being displayed is suggested as a result of corresponding differences between the times of arrival of the optic nerve signals in the brain. This effect, in which the left-hand eye and the right-hand eye perceive different light intensities, can be enhanced by designing the pyramidal elements with gradual differences in height for the left-hand eye and the right-hand eye.

GB-1 541 215 discloses a foil which comprises optically refractive pyramidal elements, the triangular bases of which adjoin one another. A side of the foil is provided with the elements, while the other side is planar to form a broken up light pattern on a light receiving medium. The light falling on the elements is broken up in a pattern of dots, which pattern is received by the medium of a photographic member. Such a screen improves the quality of a final print in photo engraving and photo lithographic processes, and has also a beneficial effect in the reproduction of light gradations and reduces the need for lens filters in such processes.

EP-1 122 559 which represents the most pertinent prior art wherefrom claim 1 is delimited discloses a foil, which foil comprises optically refractive pyramidal elements, each having a triangular base. The pyramidal elements are regular triangular pyramids having a bottom side of 10 μm-50 μm and having a top side or apex angle, also called vertical angle, of 102°-116°. Such a light collecting film condenses light incident on the flat side of the foil to light on the pyramid side emerging closer to the normal of the foil.

The object of the present invention is to provide a foil for instance having the capability of diffusing light impinging thereon.

In order to accomplish that objective, the foil according to the invention is characterized in that the pyramidal elements have respective apex angles which have been selected in dependence on a desired optical refraction.

It has been found that the foil as a whole has optically refractive characteristics upon incidence of electromagnetic waves thereon, which characteristics render the foil suitable for imparting a desired pattern in the desired direction to the exiting waves. Said pattern may be a uniformly distributed pattern, for example, as a result of which waves from a concentrated light source, for example, can surprisingly be distributed and rendered diffuse.

In addition, such a uniform pattern appeared to be useful in solving the well-known viewing angle problem, which arises when viewing images at a (usually limited) viewing angle on display screens, such as flat-panel display screens or LCD screens. The limitation of the viewing angle is eliminated by affixing the foil to the display screen, so that the image being displayed can be viewed more easily from any practical angle.

In this respect it is to be noted that in the reverse case the inventor found that if for example the foil is positioned on a solar panel system the efficiency thereof can be improved significantly, due to the fact that the dependency of the power produced by the system on the angle of incidence of the solar light is reduced. Such a system now uses the direct solar energy as well as the indirect solar energy at all their angles of incidence, in order to generate more electrical energy or thermal energy, dependent on the kind of solar system which is being used. So in cases wherein energy impinges on the pyramid side of the foil within a broad range of angles, all this energy is effectively concentrated on the underlying energy absorbing object.

A foil, usually a transparent foil provided with elements arranged in such a structured manner, can be produced by means of relatively simple techniques.

Another embodiment of the foil according to the invention is characterized in that the elements have identical dimensions. In practice, the dimension of the sides of the base of the elements will range from 1-200 μm, preferably from 5-40 μm, more preferably it will be around 10 μm, and according to a further, very simple implementation, the triangular bases may be equilateral.

Yet another embodiment of the foil according to the invention is characterized in that the elements have a height which has been selected in dependence on a desired optical refractive pattern.

It has been found that it is possible to vary the refractive pattern or the light distribution when an electromagnetic light source is used by varying the height of the pyramidal elements on the foil. Thus for example a uniform, diffuse spreading of light arises at equal heights of the pyramids.

It has furthermore been found that the optical refraction of the incident waves, and thus the diffusion of the exiting waves, can likewise be influenced by varying the apex angles of the pyramidal elements between 30° and 80°.

The lighting system, which comprises the foil and a light source that irradiates said foil, is according to the invention characterized in that the distance between the foil and the light source is variable.

Furthermore it is possible to effect a change in the light refraction pattern by varying the distance between the foil and the light source, whether or not in combination with one or more of the aforesaid aspects.

The bases of the pyramidal elements may face towards the light source or away from the light source. This depends on the way the foil is used.

A lighting system exhibiting a desired exiting light can thus the obtained by selecting the heights of the pyramidal elements in dependence on the desired light distribution, or by selecting the magnitude of the apex angles in dependence on the desired to light distribution, or by combinations of these two possibilities.

In practice, the foil may be used as an optically refractive foil for imparting a desired refraction pattern to electromagnetic waves, such as light, for example visible light, or microwave radiation, such as in a magnetron. In this connection the distribution or diffusion according to a desired intensity pattern of electromagnetic waves, e.g. from a (usually concentrated) light source, such as an incandescent lamp, a TL tube or the like, or a light reflector, may be considered. The foil furthermore has an anti-reflection effect and prevents radiance. Furthermore, the foil may be provided in front of or on lighting systems, such as lighting fixtures or lighted or light-transmitting objects, for example traffic signs or signposts, windows, lighting coves, skylights and the like. Also the use of the foil for the purpose of improving the readability of indicating instruments in vehicles, such as cars, aircraft or vessels should be considered. Furthermore, the use of the foil in scientific, optical appliances, for example spectrometers, or LCD screens or plasma screens, photo and/or video cameras and the like. Yet further applications are possible in lampshades, curtains, sunshades, theatre stages, wall lighting, lighted screening units for partitioning spaces, as well as for toys or gimmicks.

In the case of thermal radiation it is also possible, depending on the frequency range in which the foil is active, to create a desired, usually evenly distributed heat pattern.

The present invention and its further advantages will now be explained in more detail with reference to the appended drawing, in which like parts are indicated by the same numerals in various Figures. In the drawing:

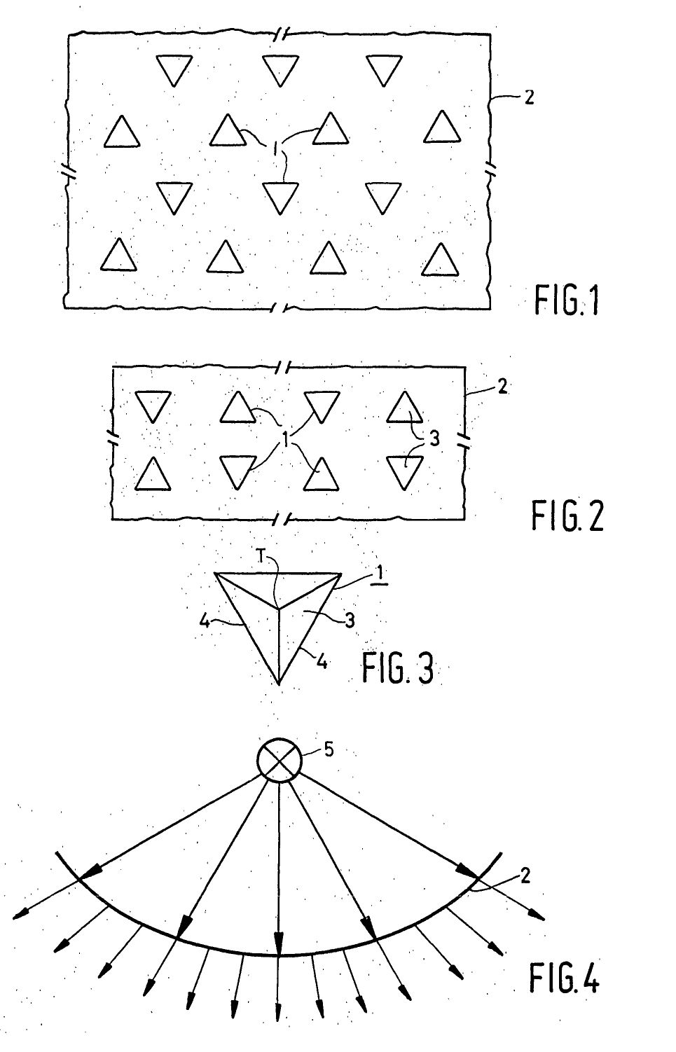

FIG. 1 is a schematic representation of a first possible arrangement of optically refractive elements provided on the foil according to the invention;

FIG. 2 shows a second possible arrangement in matrix formation of said elements;

FIG. 3 shows a detail of an optically refractive, pyramidal element for use on the foil or FIG. 1; and

FIG. 4 shows the foil of FIG. 1 or 2 as used in combination with a light-emitting line source, such as the TL tube.

FIG. 1 shows a first possible arrangement with a high occupation density of elements 1 that refract electromagnetic waves, which elements are provided on or in a foil 2 which usually transmits said waves. The elements 1, which give the underlying foil layer a relief structure, as it were, may also be integrated in a CRT screen, a plasma screen or an LCD screen or the like, but it is also possible for the foil to be removably affixed to the display screen. Each element 1 has a triangular base 3, and the bases 3 of adjacent elements 1 are turned 180 degrees relative to each other.

FIG. 2 shows another possible arrangement of the elements 1 in a matrix formation comprising rows and columns, wherein the elements 1 of each row and/or column are turned 180 degrees relative to each other.

The electromagnetic waves may have any desired frequency. The frequency may range within the visible light spectrum, for example, or within the thermal radiation range, viz. the infrared spectrum. The foil 2 may transmit the waves, but this is not necessary; in practice, however, the foil will often be made of a light-transmitting plastic material, such as polyethylene or polypropylene. The elements 1 may be provided on the foil 2, but they may also be cut out of the foil. Known techniques for achieving this include: laser or x-ray techniques, I-beam techniques and high-precision diamond cutting.

FIG. 3 shows a detail of the optically refractive, pyramidal element 1 comprising an apex angle T, which is positioned centrally above the base 3 in the top plan view as shown. The dimensions of all the elements 1 may be identical, or they may vary with each row and/or column. Generally, in order to obtain refraction in the desired frequency range, the sides 4 of the base 3 will have dimensions ranging from 1-200 μm, preferably from 5-40 μm, more preferably around 10 μm. Besides the frequency range in question, also the technique that is used as well as the cost aspect generally play a part in this regard. In a simple embodiment, the triangular base 3 is equilateral, in which case the angles of the side faces of the pyramids may be 60 degrees, which, in the case of a side length of e.g. 10 μm, will lead to a useful practical height of approximately 7.5 μm of the pyramids. If a homogenous and uniform refractive pattern of the waves incident on the foil is desired, the triangular base 3 must be equilateral.

FIG. 4 is a schematic representation of a light source 5, which may be point source, for example, such as an incandescent lamp or a low-energy lamp. The representation can also be seen as a sectional view, in which case the light source may be a line source, such as a TL tube, extending perpendicularly to the plane of the drawing, around which the foil 2 is provided. The foil 2 forms the lampshade in that case, or it is integrated therein. As a result of the refraction effected by the pyramidal elements 1, the light source is not perceptible from the outside, or only diffusely so, but it will nevertheless transmit all the emitted light without impediment. Apart from the above-mentioned possibilities of variation as regards the dimension, the angles of the side faces, the shape, the height, the type of material and the like, also variables such as the magnitude of the apex angle in relation to the desired optical refraction pattern and the distance between the foil 2 and the light source 5 are important for obtaining a desired refraction pattern or controlling the light refraction. Thus a deviation in the height of the optical elements 1 will lead to a deviation in the light distribution, as a result of which it becomes possible to control the light distribution, as it were. In the case of a varying distance between the foil 2 and the light source 5, the same light distribution can be realised by suitably varying the apex angle, and in the case of a fixed distance being used, a variable energy distribution may be obtained by varying the apex angle between 30°-80°. If—as preferred—the apex angle together with the other angles in the sides and bottom of the pyramids is around 60° and the dimension of each side is 10 μm the height lies around 7.5 μm.

If the foil is applied on top of a solar light system or solar heat system, it is no longer required to face such systems towards the sun for acquiring an optimal efficiency, as the foil structure makes the output energy practically independent from the angle of incidence of the sun waves. The same applies for solar cells, such as used in calculators, watches and the like.

It is found that the foil turns polarised light back to not polarised normal light.

It stands to reason that all kinds of combinations of the aforesaid variation possibilities will be apparent to those skilled in this field of the art.

1-18. (canceled)

19. A foil comprising:
optically refractive pyramidal elements, each having a triangular base, such that the bases of adjacent elements are turned 180 degrees relative to each other,
wherein the pyramidal elements have respective apex angles configured to provide a desired optical refraction.

20. A foil according to claim 19, wherein the bases are divided into adjacent rows, with the bases of the elements of adjacent rows being turned through 180 degrees relative to each other.

21. A foil according to claim 19, wherein the pyramidal elements have identical dimensions.

22. A foil according to claim 19, wherein a dimension of sides of the bases of the pyramidal elements ranges from 1-200 μm, or from 5-40 μm, or is around 10 μm.

23. A foil according to claim 19, wherein the triangular base is equilateral.

24. A foil according to claim 19, wherein the pyramidal elements have a height configured to provide a desired optical refractive pattern.

25. A foil according to claim 19, wherein the apex angle lies between 30°-80°.

26. A foil according to claim 19, wherein the apex angle is around 60°.

27. A foil according to claim 19, wherein the height of the pyramidal elements lies around 7.5 μm.

28. A lighting system comprising:
the foil according to claim 19; and
a light source irradiating the foil, wherein the distance between the foil and the light source is variable.

29. A lighting system according to claim 27, wherein the bases of the pyramidal elements may be directed towards the light source or away from the light source.

30. A lighting system according to claim 28, wherein the respective heights of the pyramidal elements are configured to provide a desired light distribution.

31. A lighting system according to claim 19, wherein the respective apex angles of elements are configured to provide a desired light distribution.

32. Use of the foil according to claim 19, wherein the optically refractive foil is used for imparting a desired refraction pattern to electromagnetic waves, visible light, heat waves, infrared light waves, or ultraviolet waves.

33. Use of the foil according to claim 32, wherein the foil is used for being affixed to a display screen.

34. Use of the foil according to claim 32, wherein the foil is used for being affixed to solar panels and/or solar cells.

35. A display screen provided with a foil according to claim 19.

36. A solar system provided with a foil according to claim 19.
